(19) United States
(12) Patent Application Publication
(10) Pub. No.: US 2023/0212368 A1
(43) Pub. Date: Jul. 6, 2023

(54) FLAME RETARDANT STYRENE POLYMER COMPOSITION AND PROCESS FOR RECYCLING STYRENE POLYMER-CONTAINING SCRAP

(71) Applicant: BASF SE, Ludwigshafen am Rhein (DE)

(72) Inventors: Ingo BELLIN, Ludwigshafen am Rhein (DE); Franz-Josef DIETZEN, Ludwigshafen am Rhein (DE); Heinz HERBST, Kaisten (CH)

(21) Appl. No.: 18/008,691

(22) PCT Filed: Jun. 7, 2021
(86) PCT No.: PCT/EP2021/065175

§ 371 Date: Dec. 7, 2022

(30) Foreign Application Priority Data
Jun. 10, 2020 (EP) 20179288.4

(51) Int. Cl. C08J 11/06; C08K 5/098; C08K 5/02; C08J 9/18; C08J 9/14; C08J 9/00

(52) U.S. Cl. CPC C08J 11/06; C08K 5/098; C08K 5/02; C08J 9/18; C08J 9/141; C08J 9/0052; C08J 9/0061; C08J 9/0019; C08J 2325/06; C08J 2201/03; C08J 2453/02; C08K 2201/014

(57) ABSTRACT

The present invention provides a flame-retardant styrene polymer composition comprising an organic bromine compound, zinc stearate and calcium stearate, the use for preparing styrene polymer films or foams and a process for recycling of styrene polymer-containing scrap.

The present invention relates to a flame-retardant styrene polymer composition comprising an organic bromine compound, a zinc compound and a calcium compound, the use of the composition for preparing styrene polymer films or foams and a process for recycling of styrene polymer-containing scrap.

WO 98/16579 A1 discloses heat stabilized, flame retardant polymer compositions including a halogen-based flame retardant such as hexabromocyclododecane, zeolite A heat stabilizer, and a transition metal compound such as a zinc stearate lubricant. The compositions are stable at high temperatures even when subjected to multiple heating processes.

WO 2012/016906 relates to polymer mixtures comprising at least one polymer, at least one organic halogenated compound such as halogenated flame retardant, and at least one further compound, such as polyols partially esterified with carboxylic acids, for example glycerol monostearate for thermal stabilization of the organic halogenated compound

WO 2010/080285 teaches that aliphatic bromine-containing polymers are stabilized using a mixture of an alkyl phosphite and an epoxy compound. This stabilizer package is very effective at preventing cross-linking reactions from occurring when the aliphatic bromine-containing polymer is subjected to high temperatures as are seen in melt processing operations. The stabilized aliphatic bromine-containing polymer is useful as a flame retardant for other polymers, notably polystyrene foam.

DE 10 2016 125 506 A1 relates to a method for recycling EPS foams comprising halogen containing flame retardants, wherein said EPS foams in the presence of a halogen scavenger, preferably calcium hydroxide, are extruded, cooled and further reduced to particles.

EP 2 957 413 A1 discloses a method for degassing flame retardant, propellant-containing polymer granules or recycled flame-retardant foam particles by melting and extruding the polymer melt through a degassing device, wherein a stabilizer mixture, comprising (a) hydrotalcite as an acid scavenger (S1), (b) optionally a phosphite stabilizer (S2) and (c) optionally one or more of (a) and (b) various stabilizers (S3), is added to the flame retardant, propellant-containing polymer granules or recycled flame-retardant foam particles before melting, and use of the method devolatilized polymer melt or devolatilized polymer granules for producing flame-retardant styrene polymer foams.

WO 2019/030756 A1 discloses a composition comprising polystyrene; brominated poly[styrene-co-butadiene]; a heat stabilizer; a metal salt of stearic acid; characterized in that the composition further comprises a color stabilizer selected from nitrogen-containing compounds with carbonyl groups bonded to nitrogen atoms, e.g. hydrazide or oxamides.

CN 109 233 127 A relates to an extrusion molding plate with a good surface microstructure, low thermal conductivity and good flame-retardant properties and a preparation method of the extrusion molding plate comprising 72-94 wt.-% of polystyrene, 2-16 wt-% of graphite and 2-16 wt % of a flame retardant.

U.S. Pat. No. 3,535,408 A disclose scrap foamed vinyl aromatic polymeric material, which is recovered by forming the scrap into dense granules, impregnating the granules with a low boiling hydrocarbon blowing agent, blending the blowing agent-containing granules with fresh foamable polymeric particles, and subjecting the resulting mixture to a processing step, such as sheet extrusion, involving heat plastification of the polymeric material.

EP 2 025 700 A1 relates to a process for the production of an expandable polystyrene comprising a brominated hydrocarbon as primary flame-retardant additive and a peroxide as secondary flame-retardant additive by (1) mixing a formed polystyrene (a) with a first masterbatch of one or more additives other than flame retardant additives and (b) with a blowing agent, at a temperature of at least 175° C. to form a blended melt, (2) mixing said blended melt with the primary flame retardant additive at temperature of less than 175° C., (3) subsequently mixing said melt with the secondary flame retardant additive at a temperature of less than 150° C., and (4) granulating the final blended polystyrene.

Polystyrene often contains Zn-stearate as lubricant. Zn-salts, however, are lowering the thermal stability of bromine-containing flame retardants. Decomposition of bromine-containing flame retardants and discoloration of flame-retardant polystyrene compositions comprising Zn-stearate are often observed when processing such compositions at higher temperatures.

During mechanical-thermal recycling often Zn-stearate and/or brominated flame-retardant containing polystyrene scrap, especially from recycled expandable polystyrene (EPS) or extruded polystyrene foams (XPS), is mixed resulting in decomposition of the flame retardant and discoloration of polystyrene during following thermal processing steps.

The present invention was made in view of the prior art described above, and the object of the present invention is to provide a flame-retardant styrene polymer-containing composition, which can be prepared from recycled Zn-stearate containing styrene polymer scrap and reused for the manufacturing of styrene polymer films or foams with good flame-retardant properties at low bromine content.

To solve this problem, the present invention provides a flame-retardant styrene polymer composition comprising

300 to 15.000 ppm, preferably 1000 to 13.000 ppm bromine,

10 to 1000 ppm, preferably 50 to 500 zinc, and

10 to 1000 ppm, preferably 15 to 660 ppm calcium.

Bromine, zinc and calcium are determined by elemental analysis. Inductively coupled plasma (ICP) based techniques can quantitatively measure bulk element composition. For determination of zinc and calcium optical emission spectroscopy (OES) is preferably used for intensity measurement and converted to an elemental concentration by comparison with calibration standards. Bromine is preferably determined by combustion and subsequent titration with silver ions.

In the flame-retardant styrene polymer composition bromine is preferably present as organic bromine compound, zinc is preferably present as zinc stearate, and calcium is preferably present as calcium stearate.

A preferred flame-retardant styrene polymer composition comprises
a) 70 to 99 wt.-% of styrene polymer (SP)
b) 0.5 to 3 wt.-% of an organic bromine compound as flame-retardant (FR)
c) 0.01 to 1 wt.-% of zinc stearate,
d) 0.01 to 1.5 wt.-% of calcium stearate, and
e) 0 to 24.5 wt.-% of additives (A).

More preferably the flame-retardant styrene polymer composition comprises
a) 78.5 to 97 wt.-% of styrene polymer (SP)
b) 0.5 to 3 wt.-% of an organic bromine compound as flame-retardant (FR)
c) 0.01 to 1 wt.-% of zinc stearate,
d) 0.01 to 1.5 wt.-% of calcium stearate, and
e) 2 to 16 wt.-% of additives (A).

Suitable styrene polymers (SP) are homo- or copolymers which comprise, incorporated into the polymer, units of vinylaromatic monomers, in particular of styrene. Examples here are homopolystyrene (glassclear polystyrene, GPPS), high-impact polystyrene (HIPS), anionically polymerized polystyrene or high-impact polystyrene (AIPS), styrene-α-methylstyrene copolymers, acrylonitrile-butadiene-styrene polymers (ABS), styrene-acrylonitrile polymer (SAN), acrylonitrile-styrene-acrylate (ASA), styrene-acrylates such as styrene methyl acrylate (SMA) and styrene methyl methacrylate (SMMA), methyl methacrylate-butadiene-styrene (MBS), methyl methacrylate-acrylonitrile-butadiene-styrene (MABS) polymers, styrene-N-phenylmaleimide copolymers (SPMI), or a mixture thereof. The styrene polymers mentioned can be blended with polyolefins, such as polyethylene or polypropylene, and with polyphenylene ether (PPE). The styrene polymer (PS) preferably comprises 80 to 100 wt.-% of polystyrene. Most preferably polystyrene is used as styrene polymer.

In the flame-retardant styrene polymer composition, the weight ratio of Ca:Zn is preferably in the range from 7:1 to 1:7.

In the flame-retardant styrene polymer composition the weight ratio of Br:Zn is in the range from 10:1 to 300:1.

Most preferably in the flame-retardant styrene polymer composition, the weight ratio of Ca:Zn is in the range from 5:1 to 1:5 and the weight ratio of Br:Zn is in the range from 20:1 to 250:1.

As flame-retardant (FR) any organic bromine compound with a sufficient thermal stability and high bromine content may be used. Aliphatic, cycloaliphatic, and aromatic bromine compounds are particularly suitable, for example: brominated styrene-butadiene block copolymers, pentabromomonochlorocyclohexane, pentabromophenyl allyl ether, tetrabromobisphenol A bis (2,3-dibromo-2-methylpropyl ether), tetrabromobisphenol A bis (2,3-dibromopropyl ether), or the bis(allyl) ether of tetrabromobisphenol A.

Preferably polymeric brominated organic compounds with bromine content in the range from 40 to 90 wt.-%, more preferably in the range from 50 to 70 wt.-% are used as flame-retardant (FR).

Preferably brominated styrene-butadiene block copolymers are used. Thermally stable brominated styrene-butadiene block copolymers can be prepared as described in WO 2007/058736. More preferably the polymeric brominated flame retardant is selected from a brominated styrene-butadiene-styrene triblockcopolymer. Most preferably the polymeric brominated flame retardant comprises 80 to 98 wt.-% of at least one brominated polybutadiene block.

Preferably the weight average molecular weight M_{w} of the polymeric brominated flame-retardant is in the range from 80.00 to 180.000 g/mol, determined before bromination via gel permeation chromatography (GPC analysis) in THF against PS standards.

The polymeric brominated flame retardant is preferably selected from a brominated styrene-butadiene-styrene triblock copolymer S₁-B-S₂ with a total styrene block content of 20 to 50 wt. % and a difference in the weight average molecular weight M_{w} between block S₁ and S₂ is less than 10.000 g/mol.

Preferably the at least one brominated polybutadiene-block has a 1,2-vinyl content between 50 and 95%, based on the double bonds in the polybutadiene block before bromination.

The flame-retardant styrene polymer composition may comprise one or more additives (A), which are different from zinc stearate and calcium stearate, in total amounts for all additives in the range from 0 to 24.5, preferably in the range from 2 to 16 wt.-%. Suitable additives include acid scavengers such as Al(OH)₃, Mg(OH)₂, NaHCO₃, KOH, NaOH or hydrotalcite, stabilizers such as phosphites or sterically hindered amines or flame retardant synergists. Flame retardant synergists are thermal free-radical generators with half-life times of 6 minutes at temperatures in the range from 110 to 320° C., preferably from 140 to 290° C. It is particularly preferable to use dicumene, dicumyl peroxide, cumyl hydroperoxide, di-tert-butyl peroxide, tert-butyl hydroperoxide, or a mixture thereof.

The flame-retardant styrene polymer composition may comprise as additive (A) one or more athermanous compounds, preferably in an amount in the range from 2 to 8 wt.-%, based on the flame-retardant styrene polymer composition. Preferred athermaneous compounds are carbons such as graphite, coke, or carbon black.

The flame-retardant styrene polymer composition may comprise one or more blowing agents in an amount in the range from 2 to 8 wt.-%, based on the flame-retardant styrene polymer composition as additive (A). Suitable blowing agents include chemical or physical blowing agents. Preferred blowing agents are low boiling compounds, such as butane or pentane.

The invention is further directed to a process for recycling of styrene polymer-containing scrap comprising the steps:
a) mechanically crushing the styrene polymer-containing scrap to pieces,
b) adding calcium stearate in amounts sufficient to effectively prevent discoloration during thermal processing,
c) melting the mixture from step b),
d) optionally impregnating the melt obtained in step c) with a blowing agent, and
e) extruding and granulating the melt obtained in step c) or step d) or extruding and expanding the melt obtained in step d) with foaming.

Preferably the process for recycling of styrene polymer-containing scrap comprises the steps:
a) determining the composition of the styrene polymer-containing scrap
b) mechanically crushing the styrene polymer-containing scrap to pieces,
c) adding organic bromine compound and calcium stearate in amounts to obtain a flame-retardant styrene polymer composition as described above,
d) melting the mixture from step c),
e) optionally impregnating the melt obtained in step c) with a blowing agent, and
f) extruding and granulating the melt obtained in step d) or step e) or extruding and expanding the melt obtained in step e) with foaming.

Suitable blowing agents for impregnating the melt include chemical or physical blowing agents. Preferred blowing agents are low boiling compounds, such as alcohols, ethers or alkanes with a boiling point below 80° C., most preferably ethanol, di methyl ether, butane, pentane or gases such as nitrogen or carbon dioxide.

Flame-retardant styrene polymer masterbatches are obtained when extruding and granulating the melt without the optional impregnation step. Expandable styrene polymers may be obtained by a melt extrusion process comprising the impregnation step with a blowing agent and granulating the impregnated melt under pressure through a die plate using an underwater granulator (UWG). Foam strands or sheet may be obtained, if the melt is extruded through a die or slit to ambient pressure with foaming.

In general zinc stearate is present in the styrene polymer-containing scrap and preferably no further zinc stearate is added.

Preferably the content of zinc is determined in step a) and calcium stearate is added in step c) in an amount to achieve a weight ratio of Ca:Zn in the range from 7:1 to 1:7 in the styrene polymer composition.

Preferably the content of zinc and bromine is determined in step a) and an organic bromine compound is optionally added in step c) in an amount to achieve a weight ratio of Br:Zn is in the range from 10:1 to 300:1 in the styrene polymer composition.

Most preferably the content of zinc and bromine is determined in step a) and an organic bromine compound and calcium stearate is added in step c) in an amount to achieve a weight ratio of Ca:Zn is in the range from 5:1 to 1:5 and a weight ratio of Br:Zn is in the range from 20:1 to 250:1 in the styrene polymer composition.

The invention is further directed to the use of the flame-retardant composition according to the invention for preparing styrene polymer films or foams and a process for producing expandable styrene polymers (EPS) or extruded styrene polymer foam (XPS) comprising the steps of preparing a melt of a flame-retardant composition according to the invention and impregnating the melt with a blowing agent.

Surprisingly it was found that the destabilizing effect of zinc stearate on brominated flame-retardants can be reduced or eliminated by addition of calcium stearate. By addition of calcium stearate in the recycling process of styrene polymer-containing waste a decomposition of brominated flame-retardants and discoloration of styrene polymer can be prevented effectively.

### EXAMPLES

Hereinafter, the present invention is described in more detail and specifically with reference to the Examples, which however are not intended to limit the present invention.

Raw Materials:
PS: Zn-stearate free polystyrene (PS 153 from Ineos Styrolution)
Zn-stearate: Ligastar ZN 101 from Peter Greven
Ca-stearate: Ligastar CA 800 from Peter Greven
FR 3000 Emerald Innovation 3000 (brominated styrene-butadiene copolymer) from Lanxess
SR-130 Pyroguard SR-130 from DKS Co. Ltd.
DHT dihydro talcite (Hycite 713 from BASF)
GMS glycerine mono stearate Dimodan HR 75 B from Danisco
MD 1024 Irganox MD 1024 (steric hindered phenol) from BASF

### Examples 1-4 and Comparative Examples C1-C6

Preparation of Polymer Blends.

Polystyrene blends were prepared by premixing 100 parts per weight of polystyrene PS with the amount (parts per weight per 100 parts of PS) of flame-retardant, Zn-stearate and stabilizer as listed in Table 1 and adding the premix into the feeding section of a twin-screw extruder ZSK 25 (Coperion). The extruder had a L/D (length to diameter) ratio of 32 and was operated at a speed of 200 rpm and a throughput of 10 kg/h. The loading unit was cooled with water. All other zones were adjusted to a temperature of 180° C. The melt leaving at the nozzle head was cooled in a water bath and then granulated.

The granules were dried in an air-circulated oven. The results of the inspection before and after tempering in a drying cabinet at 220° degrees Celsius for 10 minutes are summarized in Table 1.

Preparation of Foamed Films

Flame-retardant properties of the polymer blends were tested with foam films prepared from the granulated blends. 10 g of the blended granules were dissolved in 35 g of dichloromethane with 1.66 g of pentane S (80 wt.-% n-pentane, 20 wt.-% isopentane). The solution was poured into an aluminum bowl and the solvent let be evaporated. After 5 hours the polymer film was taken out and foamed with water vapor for 1.5 minutes. The obtained polymer films were tempered in a drying cabinet at 70° degrees Celsius for 24 hours.

The foamed films sheets were exposed to the flame of a propane gas burner and the time measured till the extinction of the flame. The results are summarized in table 1.

TABLE 1
Composition, visual inspection and burning test with foamed films

| | | | | | Visual inspection | Visual inspection | Burning |
|---|---|---|---|---|---|---|---|
| | Flame retardant | Zn-stearate | Stabilizer | | before tempering | after tempering | time |
| Example | [wt.-%] | [wt.-%] | [wt.-%] | | step | step | [sec] |
| 1 | 1.5 (FR 3000) | 0.1 | 0.05 | (Ca-Stearat) | clear | Some black points | 5 |
| 2 | 1.5 (FR 3000) | 0.1 | 0.1 | (Ca-Stearat) | clear | clear | 3 |
| 3 | 1.5 (FR 3000) | 0.1 | 0.2 | (Ca-Stearat) | clear | clear | 3 |
| 4 | 1.5 (SR-130) | 0.1 | 0.1 | (Ca-Stearat) | clear | clear | 5 |
| C1 | 1.5 (FR 3000) | — | — | | clear | Partially black | 4 |
| C2 | 1.5 (FR 3000) | 0.1 | — | | grey | black | 7 |
| C3 | 1.5 (FR 3000) | 0.1 | 0.1 | (MD 1024) | clear | black | 4 |
| C4 | 1.5 (FR 3000) | 0.1 | 0.2 | (MD 1024) | clear | Mostly black | 3 |
| C5 | 1.5 (FR 3000) | 0.1 | 0.1 | (DHT) | clear | black | 14 |
| C6 | 1.5 (FR 3000) | 0.1 | 0.1 | (GMS) | clear | black | 15 |

1.-12. (canceled)

13. Flame-retardant styrene polymer composition comprising
300 to 15,000 ppm bromine,
10 to 1000 ppm zinc, and
10 to 1000 ppm calcium.

14. Flame-retardant styrene polymer composition according to claim 13, wherein bromine is present as organic bromine compound, zinc is present as zinc stearate, and calcium is present as calcium stearate.

15. Flame-retardant styrene polymer composition according to claim 13, comprising
a) 70 to 99 wt.-% of styrene polymer (SP)
b) 0.5 to 3 wt.-% of an organic bromine compound as flame-retardant (FR)
c) 0.01 to 1 wt.-% of zinc stearate,
d) 0.01 to 1.5 wt.-% of calcium stearate, and
e) 0 to 24.5 wt.-% additives (A), selected from. acid scavengers, stabilizers, flame retardant synergists, athermanous compounds, blowing agents or mixtures therefrom.

16. Flame-retardant styrene polymer composition according to claim 13, wherein the weight ratio of Ca:Zn is in the range from 7:1 to 1:7.

17. Flame-retardant styrene polymer composition according to claim 13, wherein the weight ratio of Br:Zn is in the range from 10:1 to 300:1.

18. Flame-retardant styrene polymer composition according to claim 13, wherein the weight ratio of Ca:Zn is in the range from 5:1 to 1:5 and the weight ratio of Br:Zn is in the range from 20:1 to 250:1.

19. Flame-retardant styrene polymer composition according to claim 13, wherein the flame retardant is selected from brominated styrene-butadiene-block copolymer pentabromomonochlorocyclohexane, pentabromophenyl allyl ether, tetrabromobisphenol A bis (2,3-dibromo-2-methylpropyl ether), tetrabromobisphenol A bis (2,3-dibromopropyl ether), or the bis(allyl) ether of tetrabromobisphenol A or mixtures therefrom.

20. A process for recycling of styrene polymer-containing scrap comprising the steps:
a) determining the content of bromine, zinc and calcium of the styrene polymer-containing scrap
b) mechanically crushing the styrene polymer-containing scrap to pieces,
c) adding organic bromine compound, calcium stearate and optionally zinc stearate in amounts to obtain a flame-retardant styrene polymer composition according to claim 13,
d) melting and extruding the mixture from step c)
e) optionally impregnating the melt obtained in step d) with a blowing agent, and
f) extruding and granulating the melt obtained in step d) or step e) or extruding and expanding the melt obtained in step e) with foaming.

21. A process for producing a flame-retardant styrene-polymer composition according to claim 13, wherein calcium-stearate is added together with pieces of styrene polymer-containing scrap before melting the flame-retardant styrene-polymer composition.

22. A process for producing expandable styrene polymers or extruded styrene polymer foam comprising the steps of preparing a melt of a flame-retardant composition according to claim 13 and impregnating the melt with a blowing agent.

23. Use of the flame-retardant composition according to claim 13 for preparing styrene polymer films or foams.

24. Extruded styrene polymer foam (XPS) or expandable styrene polymer (EPS) comprising the flame-retardant styrene polymer composition according to claim 13.
